(19) United States
(12) Patent Application Publication
(10) Pub. No.: US 2025/0236415 A1
(43) Pub. Date: Jul. 24, 2025

(54) COMPOSITE STRUCTURE AND FLYING OBJECT

(71) Applicant: HONDA MOTOR CO., LTD., Tokyo (JP)

(72) Inventors: Hitoshi Iwadate, Wako-shi (JP); Ikumi Oyama, Wako-shi (JP); Mai Ishibashi, Wako-shi (JP)

(21) Appl. No.: 19/016,144

(22) Filed: Jan. 10, 2025

(30) Foreign Application Priority Data
Jan. 22, 2024 (JP) 2024-007597

(51) Int. Cl. B64D 45/02; B64C 1/00; B64C 1/12

(52) U.S. Cl. CPC B64D 45/02; B64C 1/12; B64C 2001/0072

(57) ABSTRACT

A composite structure includes a first composite material and a second composite material. The first composite material includes a first conductive layer and the second composite material includes a second conductive layer. The first composite material and the second composite material are laminated on a substrate. The composite structure further includes an overlapping portion and a conductive portion. The overlapping portion is formed by a first end portion of the first composite material being overlapped with a second end portion of the second composite material. The conductive portion electrically connects, in the overlapping portion, the first conductive layer located in the first end portion and the second conductive layer located in the second end portion.

### CROSS-REFERENCE TO RELATED APPLICATIONS

This application is based upon and claims the benefit of priority from Japanese Patent Application No. 2024-007597 filed on Jan. 22, 2024, the contents of which are incorporated herein by reference.

### BACKGROUND OF THE INVENTION

### Field of the Invention

The present disclosure relates to a composite structure including a substrate (a base material) and a conductive layer. The present disclosure also relates to a flying object including the substrate of the composite structure as a surface structural member, and including the conductive layer of the composite structure as a lightning protection structure.

### Description of the Related Art

The flying object may be struck by lightning during flight. To cope with this, the flying object is provided with a lightning protection structure. The lightning protection structure is, for example, a conductor provided on a surface structural material (skin). The lightning current is quickly led to a static discharger through the conductor and discharged into the air.

The surface structural member is made of, for example, a fiber-reinforced resin. The conductor is, for example, a metal mesh. In JP 2020-059841 A, a layered composite member in which a metal mesh is impregnated with a matrix resin is called an integrated surface protection system, and is laminated on the surface structural member. In the matrix resin, reinforcing fibers formed of chopped fibers are dispersed.

### SUMMARY OF THE INVENTION

In a case where the layered composite member is laminated on the surface structural member, it is conceivable that a part of a roll body obtained by winding the layered composite member in a roll shape is cut into a predetermined length to obtain a sheet-shaped body, and the sheet-shaped body is joined to the surface structural member.

The height of the roll body in a direction orthogonal to the winding direction is about 1 m. In contrast, the length of the fuselage of the flying object is, for example, several meters to several tens of meters. Therefore, in order to provide the lightning protection structure on the entire surface structural member of the fuselage, it is necessary to join a plurality of sheet-shaped bodies to the surface structural member of the fuselage.

In a case where a gap is formed between two adjacent sheet-shaped bodies, rainwater or the like may enter the gap, and the weather resistance, strength, and the like of the surface structural member may be reduced. In order to avoid this situation, it is conceivable to overlap the end portion of one of the two adjacent sheet-shaped bodies with the end portion of the other sheet-shaped body. However, in this configuration, it is assumed that the conductor included in the sheet-shaped body positioned on the lower side and the conductor included in the sheet-shaped body positioned on the upper side are not in electrical contact with each other in the overlapping portion. In this case, it is not easy to maintain lightning protection performance.

The present disclosure has the object of solving the above-described problem.

According to a first aspect of the present disclosure, there is provided a composite structure comprising: a substrate; and a first composite material and a second composite material that are disposed on a surface of the substrate, wherein the first composite material is a sheet-shaped body including a first fiber layer, a first conductive layer laminated on the first fiber layer, and a first matrix resin impregnated into the first fiber layer and the first conductive layer, and the first composite material is laminated on the substrate in a manner so that the first fiber layer is positioned between the substrate and the first conductive layer, the second composite material is a sheet-shaped body including a second fiber layer, a second conductive layer laminated on the second fiber layer, and a second matrix resin impregnated into the second fiber layer and the second conductive layer, and the second composite material is laminated on the substrate in a manner so that the second fiber layer is positioned between the substrate and the second conductive layer, and the composite structure includes: an overlapping portion formed by a first end portion of the first composite material being overlapped with a second end portion of the second composite material; and a conductive portion configured to electrically connect, in the overlapping portion, the first conductive layer located in the first end portion and the second conductive layer located in the second end portion.

According to a second aspect of the present disclosure, there is provided a flying object comprising the above-described substrate as a surface structural member, and comprising the above-described first conductive layer and the above-described second conductive layer as a lightning protection structure.

According to the present disclosure, the first conductive layer and the second conductive layer can be used as a lightning protection structure. In this case, since the first conductive layer and the second conductive layer are electrically connected to each other by the conductive portion, it is possible to balance the potential of the first conductive layer and the potential of the second conductive layer. As a result, the composite structure can maintain lightning protection performance. In addition, since the first composite material and the second composite material can be arranged on the end surface of the substrate without a gap, the composite structure exhibits sufficient weather resistance and durability. Further, strength of the composite structure is maintained.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic perspective view of a multicopter which is an example of a flying object;

FIG. 2 is a schematic cross-sectional view of principal components along a thickness direction of the multicopter to which a composite structure according to a first embodiment is applied;

FIG. 3 is a schematic cross-sectional view of a first composite material along the thickness direction;

FIG. 4 is a schematic cross-sectional view of principal components along a thickness direction of the multicopter to which a composite structure according to a second embodiment is applied;

FIG. 5 is a schematic cross-sectional view of principal components along a thickness direction of the multicopter to which a composite structure according to a third embodiment is applied; and

FIG. 6 is a schematic cross-sectional view of principal components along a thickness direction of the multicopter to which a composite structure according to a fourth embodiment is applied.

### DETAILED DESCRIPTION OF THE INVENTION

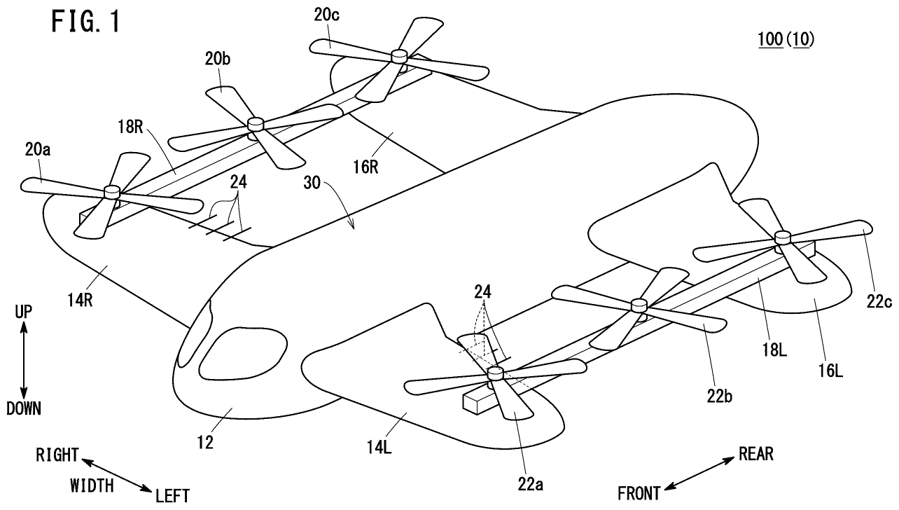

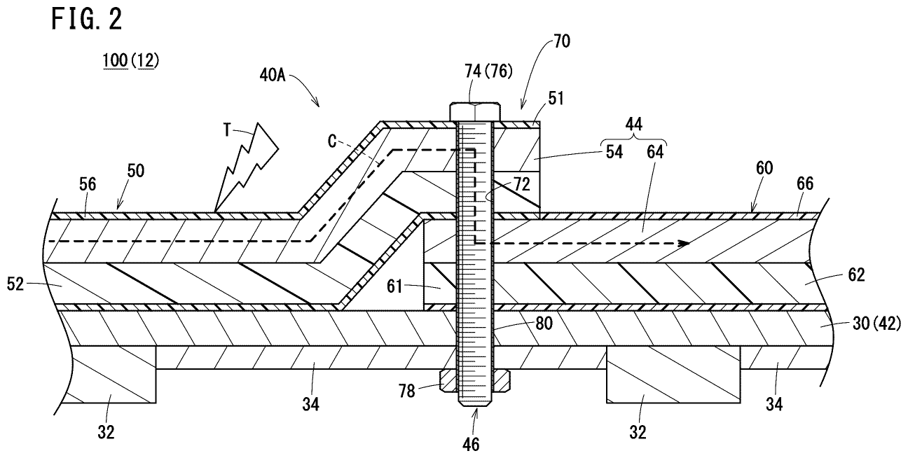

In the following, a case will be exemplified in which a second composite material 60 (see FIG. 2) is disposed at a position closer to static dischargers 24 than a first composite material 50 on the surface of a fuselage 12 (see FIG. 1), and a lightning current C flows from a first conductive layer 54 to a second conductive layer 64.

FIG. 1 is a schematic perspective view of a flying object 100. In the illustrated example, the flying object 100 is a multicopter 10. However, the flying object 100 is not limited to the multicopter 10.

The multicopter 10 includes the fuselage 12. A left main wing 14L and a right main wing 14R protrude in a width direction from a left front side portion and a right front side portion of the fuselage 12, respectively. A left horizontal stabilizer 16L and a right horizontal stabilizer 16R protrude in the width direction from a left rear side portion and a right rear side portion of the fuselage 12, respectively. A left support bar 18L straddles the left main wing 14L and the left horizontal stabilizer 16L. A right support bar 18R straddles the right main wing 14R and the right horizontal stabilizer 16R.

The right main wing 14R, the right support bar 18R, and the right horizontal stabilizer 16R are provided with a propeller 20a, a propeller 20b, and a propeller 20c, respectively. The left main wing 14L, the left support bar 18L, and the left horizontal stabilizer 16L are provided with a propeller 22a, a propeller 22b, and a propeller 22c, respectively. The six propellers 20a to 20c and 22a to 22c are lift generating devices. The multicopter 10 takes off and flies through the air as the six propellers 20a to 20c and 22a to 22c rotate.

For example, a plurality of static dischargers 24 are provided on each of the left main wing 14L and the right main wing 14R. The static dischargers 24 are well known, and therefore, a detailed description thereof will be omitted. The static dischargers 24 may be provided at locations other than on the left main wing 14L and the right main wing 14R.

FIG. 2 is a schematic cross-sectional view of principal components of an outer surface of the fuselage 12, as viewed along a thickness direction thereof. The downward direction of FIG. 2 is a direction toward an inner portion of the fuselage 12 (for example, a passenger compartment), and the upward direction of FIG. 2 is a direction toward an outer portion of the fuselage 12. The leftward direction of FIG. 2 is a direction toward the front of the fuselage 12 (a flight direction), and the rightward direction of FIG. 2 is a direction toward the rear of the fuselage 12 (a direction opposite to the flight direction). The fuselage 12 includes a surface structural member 30, a plurality of frames 32, and a plurality of stringers 34. As is well known, each frame 32 is substantially ring-shaped, and each stringer 34 extends along the front-rear direction of the fuselage 12. The frames 32 and the stringers 34 function as reinforcing members.

The surface structural member 30 is sometimes referred to as a skin. In FIG. 2, the shape of the surface structural member 30 is simplified for easy understanding, but the actual surface structural member 30 is formed into an appropriate shape that matches the outer shape of the multicopter 10.

The fuselage 12 is provided with a composite structure 40A. The composite structure 40A includes the surface structural member 30 as a substrate 42, and further includes the first composite material 50 and the second composite material 60 disposed on the surface of the surface structural member 30.

The surface structural member 30 (the substrate 42) is made of, for example, a fiber-reinforced resin containing carbon fibers as reinforcing fibers. The carbon fibers have a laminated structure of, for example, a first cloth layer, a first unidirectional (UD) layer, a second UD layer, and a second cloth layer. The fabric as the material of the first cloth layer and the second cloth layer, and the fabric as the material of the first UD layer and the second UD layer are well known. Therefore, detailed description and illustration of the first cloth layer, the first UD layer, the second UD layer, and the second cloth layer will be omitted. The first cloth layer, the first UD layer, the second UD layer, and the second cloth layer are impregnated with a substrate matrix resin such as an epoxy resin. Alternatively, the surface structural member 30 (the substrate 42) may be made of a metal material such as aluminum.

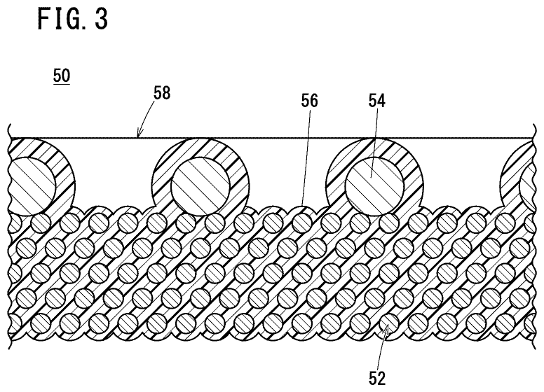

As shown in FIGS. 2 and 3, the first composite material 50 includes a first fiber layer 52, the first conductive layer 54 laminated on the first fiber layer 52, and a first matrix resin 56 impregnated into the first fiber layer 52 and the first conductive layer 54. The first fiber layer 52 is formed of, for example, one carbon fiber layer. The carbon fiber layer is preferably a cloth layer.

The first conductive layer 54 is formed of a layered conductor. When the first composite material 50 is laminated on the surface structural member 30, the first fiber layer 52 is positioned between the surface structural member 30 and the first conductive layer 54. The first conductive layer 54 constitutes a lightning protection structure 44 in the multicopter 10.

As a specific example of the conductor, there may be cited a metal mesh 58 shown in FIG. 3. The metal mesh 58 is preferably formed of a copper mesh or an aluminum mesh. The copper mesh or the aluminum mesh is a satisfactory electrical conductor, and further has a superior weather resistance. In a case where an aluminum mesh is used, it is desirable to subject the aluminum mesh to a pretreatment. The pretreatment is performed for preventing electrolytic corrosion from occurring between aluminum and the fibers (for example, carbon fibers) included in the first fiber layer 52.

In the first composite material 50, there may be cases where the first conductive layer 54 is in direct contact with the first fiber layer 52. The first matrix resin 56 is impregnated into the first fiber layer 52 and the first conductive layer 54 which are in contact with each other. In other words, the first matrix resin 56 covers the first fiber layer 52 and the first conductive layer 54. In a case where the conductor is the metal mesh 58, the first matrix resin 56 enters the mesh openings of the metal mesh 58. However, FIG. 2 schematically shows that the first conductive layer 54 and the first fiber layer 52 are sandwiched between two layers of the first matrix resin 56, whereby the first matrix resin 56 covers the first conductive layer 54 and the first fiber layer 52.

Although not shown, a thin layer made of the first matrix resin 56 may be interposed between the entire first fiber layer 52 and the entire first conductive layer 54. In this case, the first conductive layer 54 is not in contact with the first fiber layer 52. It should be noted that the thin layer is formed from the first matrix resin 56 that has inevitably entered between the first fiber layer 52 and the first conductive layer 54.

As another specific example of the conductor, there may be cited a nonwoven fabric whose surface is coated with a metal. The metal coated on the surface of the nonwoven fabric is referred to as a coating metal. As a suitable example of the coating metal, there may be cited silver, copper, titanium or aluminum. In this case, the first matrix resin 56 enters pores of the nonwoven fabric. When this configuration is used as the lightning protection structure 44, the lightning current C flows toward the static dischargers 24 (see FIG. 1) via the coating metal.

The nonwoven fabric on which the coating metal is formed is a conductor lighter than the metal mesh 58. Therefore, in this case, it is possible to further reduce the weight of the composite structure 40A and the multicopter 10.

As a suitable example of the resin material forming the first matrix resin 56, there may be cited an epoxy resin as in the case of the substrate matrix resin. However, the resin material of the first matrix resin 56 is not limited to the epoxy resin.

As shown in FIG. 2, the second composite material 60 is disposed adjacent to the first composite material 50 on the surface of the surface structural member 30. The second composite material 60 includes a second fiber layer 62, the second conductive layer 64 laminated on the second fiber layer 62, and a second matrix resin 66 impregnated into the second fiber layer 62 and the second conductive layer 64. When the second composite material 60 is laminated on the surface structural member 30, the second fiber layer 62 is positioned between the surface structural member 30 and the second conductive layer 64. In the multicopter 10, the second conductive layer 64 constitutes the lightning protection structure 44 together with the first conductive layer 54.

The second fiber layer 62, the second conductive layer 64, and the second matrix resin 66 have the same configurations as the first fiber layer 52, the first conductive layer 54, and the first matrix resin 56, respectively, for example. The second fiber layer 62 is formed of, for example, one carbon fiber layer in the same manner as the first fiber layer 52. In this case, the cross section of the second composite material 60 has the same structure as that shown in FIG. 3. The first composite material 50 and the second composite material 60 are, for example, sheet-shaped bodies cut out from the same roll body or different roll bodies.

The configuration of the second composite material 60 may be different from the configuration of the first composite material 50. For example, in a case where the first conductive layer 54 is a copper mesh, the second conductive layer 64 may be an aluminum mesh. The resin material of the second matrix resin 66 may be a different type from the resin material of the first matrix resin 56.

As shown in FIG. 2, the composite structure 40A includes an overlapping portion 70. The overlapping portion 70 is formed by a first end portion 51 of the first composite material 50 being overlapped with a second end portion 61 of the second composite material 60. The overlapping portion 70 prevents a gap from being formed between the first composite material 50 and the second composite material 60 adjacent to each other.

Through holes are formed in the first end portion 51, the second end portion 61, the surface structural member 30, and the stringer 34. The through holes are connected to each other to form one insertion hole 72. A fastening member 74, which is also referred to as a fastener, is inserted through the insertion hole 72. In the illustrated example, the fastening member 74 is a bolt 76. The first end portion 51, the second end portion 61, the surface structural member 30, and the stringer 34 are fastened by screwing a nut 78 onto the bolt 76. The second end portion 61 is positioned between the first end portion 51 and the surface structural member 30. It should be noted that the fastening member 74 is not limited to the bolt 76. Other examples of the fastening member 74 include a rivet. The fastening member 74 such as the bolt 76 and the rivet is a conductor made of a metal material.

The first end portion 51, the second end portion 61, the surface structural member 30, and the frame 32 may be fastened by the fastening member 74. An L-shaped coupling member (not shown) may be coupled to the stringer 34 or the frame 32, and the fastening member 74 may be fastened to the coupling member.

The fastening member 74 is a member for fastening the surface structural member 30 to the stringer 34 or the frame 32. Therefore, in this case, the overlapping portion 70 can be mechanically joined to the surface structural member 30 by the fastening member 74. It should be noted that it is not essential to fasten the first end portion 51, the second end portion 61, and the surface structural member 30 to the stringer 34 or the frame 32.

As understood from FIG. 2, a sealant 80 fills a space between the inner circumferential surface of the insertion hole 72 and the bolt 76. The sealant 80 may be conductive or insulative (non-conductive). In a case where the sealant 80 is conductive, if the first conductive layer 54 and the bolt 76 are not in contact with each other, the sealant 80 electrically connects the first conductive layer 54 and the bolt 76 to each other. In addition, in a case where the bolt 76 and the second conductive layer 64 are not in contact with each other, the conductive sealant 80 electrically connects the bolt 76 and the second conductive layer 64 to each other. Further, the bolt 76 is a conductor made of a metal material. Therefore, the bolt 76 (the fastening member 74) functions as a conductive portion 46 that electrically connects the first conductive layer 54 and the second conductive layer 64 to each other.

In a case where the bolt 76 is in electrical contact with the first conductive layer 54 and the second conductive layer 64, an insulating filler or the like can be used as the sealant 80. In this case as well, the bolt 76 (the fastening member 74) functions as the conductive portion 46 that electrically connects the first conductive layer 54 and the second conductive layer 64 to each other.

The composite structure 40A and the multicopter 10 (the flying object 100) according to the first embodiment are basically configured as described above. Next, effects of the composite structure 40A and the flying object 100 will be described.

The composite structure 40A includes the substrate 42, and the first composite material 50 and the second composite material 60 disposed on the surface of the substrate 42. The first composite material 50 is a sheet-shaped body including the first fiber layer 52, the first conductive layer 54 laminated on the first fiber layer 52, and the first matrix resin 56 impregnated into the first fiber layer 52 and the first conductive layer 54. The first composite material 50 is laminated on the substrate 42 such that the first fiber layer 52 is positioned between the substrate 42 and the first conductive layer 54. The second composite material 60 is a sheet-shaped body including the second fiber layer 62, the second conductive layer 64 laminated on the second fiber layer 62, and the second matrix resin 66 impregnated into the second fiber layer 62 and the second conductive layer 64. The second composite material 60 is laminated on the substrate 42 such that the second fiber layer 62 is positioned between the substrate 42 and the second conductive layer 64.

The composite structure 40A includes: the overlapping portion 70 formed by the first end portion 51 of the first composite material 50 being overlapped with the second end portion 61 of the second composite material 60; and the conductive portion 46 that electrically connects, in the overlapping portion 70, the first conductive layer 54 located in the first end portion 51 and the second conductive layer 64 located in the second end portion 61.

Since the first conductive layer 54 and the second conductive layer 64 are electrically connected to each other via the conductive portion 46, for example, the first conductive layer 54 and the second conductive layer 64 can be used as the lightning protection structure 44. In this case, when lightning T falls on the first composite material 50 of the composite structure 40A, for example, dielectric breakdown or the like occurs in the composite structure 40A. As a result, the lightning current C flows through the first conductive layer 54 and the second conductive layer 64. Consequently, the potential of the first conductive layer 54 and the potential of the second conductive layer 64 can be balanced, and thus lightning protection performance can be maintained.

Further, since the first end portion 51 of the first composite material 50 is overlapped with the second end portion 61 of the second composite material 60, the first composite material 50 and the second composite material 60 can be arranged on the surface of the substrate 42 without a gap. Therefore, the composite structure 40A exhibits sufficient weather resistance and durability. In addition, the strength of the composite structure 40A is maintained.

The flying object 100 includes the substrate 42 as the surface structural member 30, and includes the first conductive layer 54 and the second conductive layer 64 as the lightning protection structure 44.

When the flying object 100 is struck by lightning, the lightning current C flows along the first conductive layer 54 and the second conductive layer 64 that constitute the lightning protection structure 44. Therefore, the lightning current C can be easily led to the static dischargers 24 and discharged to the atmosphere.

The above effects are similarly obtained in the second to fourth embodiments described later. According to the first embodiment, the following peculiar effects can be further obtained.

The conductive portion 46 is the fastening member 74 that fastens the substrate 42, the first end portion 51, and the second end portion 61. That is, the fastening member 74 used for fastening the substrate 42, the first end portion 51, and the second end portion 61 can be utilized as the conductive portion 46. Therefore, the first conductive layer 54 and the second conductive layer 64 can be electrically connected to each other without performing special processing on the composite structure 40A.

The insertion hole 72 through which the fastening member 74 is inserted is formed in the substrate 42, the first end portion 51, and the second end portion 61. The sealant 80 fills a space between the inner circumferential surface of the insertion hole 72 and the fastening member 74.

The sealant 80 seals between the inner circumferential surface of the insertion hole 72 and the fastening member 74. Therefore, rainwater or the like is prevented from entering the insertion hole 72, and corrosion of the fastening member 74 is therefore avoided. As a result, the joint strength between the substrate 42, the first end portion 51, and the second end portion 61 is maintained. In addition, in a case where a gap is formed between the fastening member 74 and the first conductive layer 54 or the second conductive layer 64, the gap may be filled with the conductive sealant 80. As a result, the first conductive layer 54 and the second conductive layer 64 are electrically connected to each other reliably via the fastening member 74 and the conductive sealant 80.

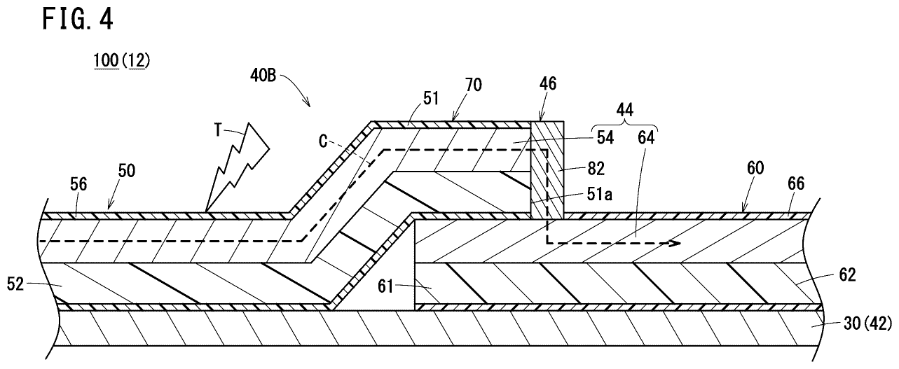

Next, a composite structure 40B according to a second embodiment will be described with reference to FIG. 4. It should be noted that the same constituent elements as those shown in FIGS. 1 to 3 are denoted by the same reference numerals, and detailed description thereof will be omitted.

The composite structure 40B includes the substrate 42, and the first composite material 50 and the second composite material 60 disposed on the surface of the substrate 42. The substrate 42 is the surface structural member 30 of the multicopter 10.

As in the first embodiment, the first composite material 50 includes the first fiber layer 52, the first conductive layer 54 laminated on the first fiber layer 52, and the first matrix resin 56 impregnated into the first fiber layer 52 and the first conductive layer 54. The second composite material 60 includes the second fiber layer 62, the second conductive layer 64 laminated on the second fiber layer 62, and the second matrix resin 66 impregnated into the second fiber layer 62 and the second conductive layer 64. The first end portion 51 of the first composite material 50 is overlapped with the second end portion 61 of the second composite material 60. The composite structure 40B includes the overlapping portion 70 formed by this overlapping. Further, the composite structure 40B includes the conductive portion 46 that electrically connects, in the overlapping portion 70, the first conductive layer 54 located in the first end portion 51 and the second conductive layer 64 located in the second end portion 61.

In the second embodiment, the conductive portion 46 is a conductive coating 82. The conductive coating 82 is formed so as to cover, in the first end portion 51, an end surface 51a extending along the thickness direction of the first composite material 50. The conductive coating 82 can be formed by, for example, applying a paste containing silver, copper, titanium, or aluminum, similarly to the above-described coating metal, to the end surface 51a and then solidifying the paste.

The conductive coating 82 is in contact with the second end portion 61. It is not necessary for the conductive coating 82 to be in contact with the stringer 34 or the frame 32. It should be noted that, in the illustrated example, the end surface 51a is a vertical surface extending along the thickness direction, but may be an inclined surface.

In the second end portion 61, the second conductive layer 64 may be exposed from the second matrix resin 66. In this case, it is easy to bring the conductive coating 82 into contact with the second conductive layer 64.

The composite structure 40B and the flying object 100 according to the second embodiment have the following peculiar effects.

The conductive portion 46 is the conductive coating 82 formed so as to cover, in the first end portion 51 of the first composite material 50, the end surface 51a extending along the thickness direction of the first composite material 50. The conductive coating 82 is in contact with the second end portion 61.

The first conductive layer 54 and the second conductive layer 64 can be electrically connected to each other via the conductive coating 82 even at locations where the fastening member 74 cannot be used in the first composite material 50 and the second composite material 60 or in the fuselage 12. Therefore, the first conductive layer 54 and the second conductive layer 64 can be used as the lightning protection structure 44 for allowing the lightning current C to flow therethrough.

In addition, the paste for forming the conductive coating 82 has excellent shape followability. Therefore, for example, even when the end surface 51a has irregularities, the conductive coating 82 can be formed on the end surface 51a so as to sufficiently cover the end surface 51a.

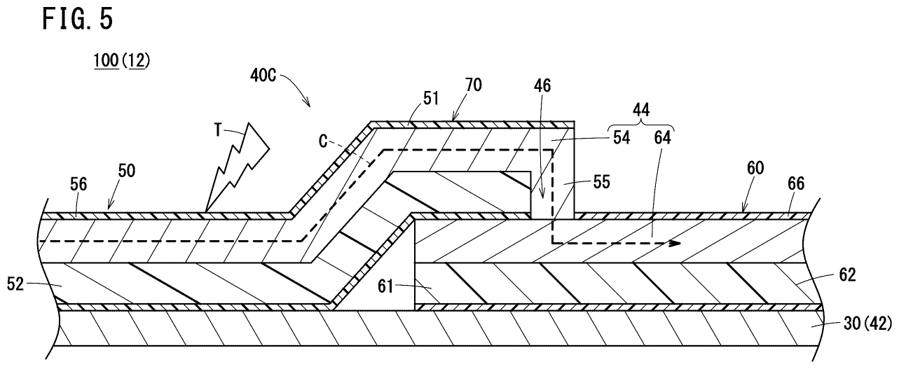

Next, a composite structure 40C according to a third embodiment will be described with reference to FIG. 5. It should be noted that the same constituent elements as those shown in FIGS. 1 to 4 are denoted by the same reference numerals, and detailed description thereof will be omitted.

The composite structure 40C includes the substrate 42, and the first composite material 50 and the second composite material 60 disposed on the surface of the substrate 42. The substrate 42 is the surface structural member 30 of the multicopter 10.

As in the first embodiment and the second embodiment, the first composite material 50 includes the first fiber layer 52, the first conductive layer 54 laminated on the first fiber layer 52, and the first matrix resin 56 impregnated into the first fiber layer 52 and the first conductive layer 54. The second composite material 60 includes the second fiber layer 62, the second conductive layer 64 laminated on the second fiber layer 62, and the second matrix resin 66 impregnated into the second fiber layer 62 and the second conductive layer 64. The first end portion 51 of the first composite material 50 is overlapped with the second end portion 61 of the second composite material 60. The composite structure 40C includes the overlapping portion 70 formed by this overlapping. Further, the composite structure 40C includes the conductive portion 46 that electrically connects, in the overlapping portion 70, the first conductive layer 54 located in the first end portion 51 and the second conductive layer 64 located in the second end portion 61.

In the third embodiment, the conductive portion 46 is an edge portion 55 of the first conductive layer 54 located in the first end portion 51. The edge portion 55 of the first conductive layer 54 is bent toward the second end portion 61 and is in contact with the surface of the second end portion 61. It is not necessary for the edge portion 55 of the first conductive layer 54 to be in contact with the stringer 34 or the frame 32. It should be noted that, in the illustrated example, the edge portion 55 is bent substantially perpendicularly, but may be bent so as to be inclined.

In the second end portion 61, the second conductive layer 64 may be exposed from the second matrix resin 66. In this case, it is easy to bring the edge portion 55 of the first conductive layer 54 into contact with the second conductive layer 64.

The composite structure 40C and the flying object 100 according to the third embodiment have the following peculiar effects.

The conductive portion 46 is the edge portion 55 of the first conductive layer 54 located in the first end portion 51. The edge portion 55 is bent toward the second end portion 61 and is in contact with the second end portion 61.

The first conductive layer 54 and the second conductive layer 64 can be electrically connected to each other via the edge portion 55 of the first conductive layer 54 even at locations where the fastening member 74 cannot be used in the first composite material 50 and the second composite material 60 or in the fuselage 12. Therefore, the first conductive layer 54 and the second conductive layer 64 can be used as the lightning protection structure 44 for allowing the lightning current C to flow therethrough. In addition, an operation such as applying the conductive coating 82 to the side surface of the first end portion 51 of the first conductive layer 54 is not required.

In this manner, according to the third embodiment, the conductive portion 46 can be easily provided.

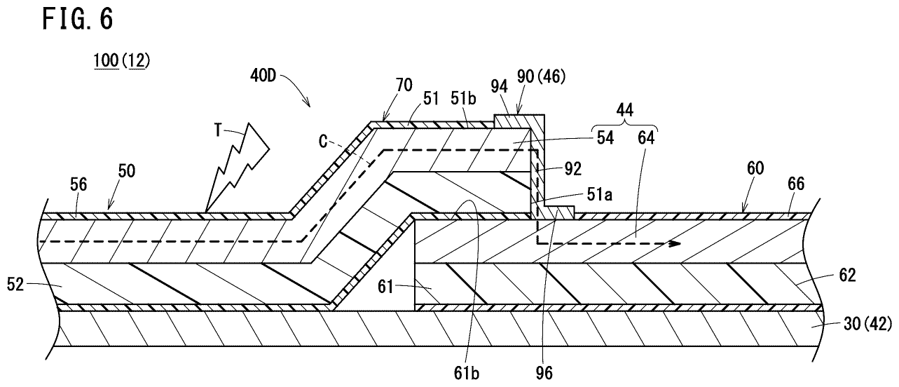

Next, a composite structure 40D according to a fourth embodiment will be described with reference to FIG. 6. It should be noted that the same constituent elements as those shown in FIGS. 1 to 5 are denoted by the same reference numerals, and detailed description thereof will be omitted.

The composite structure 40D includes the substrate 42, and the first composite material 50 and the second composite material 60 disposed on the surface of the substrate 42. The substrate 42 is the surface structural member 30 of the multicopter 10.

The first composite material 50 includes the first fiber layer 52, the first conductive layer 54, and the first matrix resin 56. The second composite material 60 includes the second fiber layer 62, the second conductive layer 64, and the second matrix resin 66. The composite structure 40D includes the overlapping portion 70 formed by the first end portion 51 of the first composite material 50 being overlapped with the second end portion 61 of the second composite material 60. The composite structure 40D includes the conductive portion 46 that electrically connects, in the overlapping portion 70, the first conductive layer 54 located in the first end portion 51 and the second conductive layer 64 located in the second end portion 61.

In the fourth embodiment, the conductive portion 46 is formed of a conductive solid 90 other than the fastening member 74 shown in FIG. 2 and the first conductive layer 54 (the edge portion 55) shown in FIG. 5. Here, the “solid” refers to a tangible object that does not exhibit viscosity or fluidity from before being provided as the conductive portion 46 in the overlapping portion 70 to after being provided as the conductive portion 46 in the overlapping portion 70. According to this definition, the conductive coating 82 shown in FIG. 4 does not correspond to the “solid”.

The conductive solid 90 is exposed to the outside of the first end portion 51 and the second end portion 61 that constitute the overlapping portion 70. That is, the conductive solid 90 does not penetrate the overlapping portion 70, unlike the fastening member 74 (see FIG. 2). As a specific example of the conductive solid 90 (see FIG. 6) that can be joined to the first end portion 51 and the second end portion 61 outside the overlapping portion 70 in this manner, there may be cited a stapler, a bonding wire, and the like.

The conductive solid 90 includes a base portion 92, a first tongue-shaped piece 94 which is bent substantially perpendicularly to one end of the base portion 92 and is continuous therewith, and a second tongue-shaped piece 96 which is bent substantially perpendicularly to the other end of the base portion 92 and is continuous therewith. The extending direction of the first tongue-shaped piece 94 and the extending direction of the second tongue-shaped piece 96 are opposite to each other. The first tongue-shaped piece 94 and the second tongue-shaped piece 96 may be bent so as to be inclined with respect to the base portion 92. In FIG. 6, the lower surface of the first tongue-shaped piece 94 is in contact with an upper surface 51b of the first end portion 51 of the first composite material 50. The lower surface of the second tongue-shaped piece 96 is in contact with an upper surface 61b of the second end portion 61 of the second composite material 60.

In the first end portion 51, the first conductive layer 54 may be exposed from the first matrix resin 56. In this case, it is easy to bring the first conductive layer 54 into contact with the lower surface of the first tongue-shaped piece 94. Similarly, in the second end portion 61, the second conductive layer 64 may be exposed from the second matrix resin 66. In this case, it is easy to bring the second conductive layer 64 into contact with the lower surface of the second tongue-shaped piece 96. It should be noted that, in the illustrated example, the base portion 92 is in contact with the end surface 51a of the first end portion 51 of the first composite material 50, but the base portion 92 may be spaced apart from the end surface 51a.

The composite structure 40D and the flying object 100 according to the fourth embodiment have the following peculiar effects, in addition to the same operational effects as those of the third embodiment.

When the conductive solid 90 is provided in the overlapping portion 70, the contact point between the first tongue-shaped piece 94 and the first composite material 50 and the contact point between the second tongue-shaped piece 96 and the second composite material 60 are joined to each other. As understood from this, according to the conductive solid 90, the conductive portion 46 can be provided in the overlapping portion 70 by a partial joining operation. That is, the joining operation for providing the conductive portion 46 is simple.

The following supplementary notes are further disclosed in relation to the above-described disclosure.

### Supplementary Note 1

The composite structure (40A, 40B, 40C, 40D) includes the substrate (42), and the first composite material (50) and the second composite material (60) that are disposed on the surface of the substrate. The first composite material is a sheet-shaped body including the first fiber layer (52), the first conductive layer (54) laminated on the first fiber layer, and the first matrix resin (56) impregnated into the first fiber layer and the first conductive layer, and the first composite material is laminated on the substrate in a manner so that the first fiber layer is positioned between the substrate and the first conductive layer. The second composite material is a sheet-shaped body including the second fiber layer (62), the second conductive layer (64) laminated on the second fiber layer, and the second matrix resin (66) impregnated into the second fiber layer and the second conductive layer, and the second composite material is laminated on the substrate in a manner so that the second fiber layer is positioned between the substrate and the second conductive layer.

The composite structure includes: the overlapping portion (70) formed by the first end portion (51) of the first composite material being overlapped with the second end portion (61) of the second composite material; and the conductive portion (46) configured to electrically connect, in the overlapping portion, the first conductive layer located in the first end portion and the second conductive layer located in the second end portion.

Since the first conductive layer and the second conductive layer are electrically connected to each other via the conductive portion, for example, the first conductive layer and the second conductive layer can be used as a lightning protection structure. In this case, when the composite structure is struck by lightning, the lightning current flows through the first conductive layer and the second conductive layer. Consequently, the potential of the first conductive layer and the potential of the second conductive layer can be balanced, and therefore, damage to the lightning protection structure can be prevented and lightning protection performance can be maintained.

Furthermore, since the lightning current easily flows in the composite structure through the first conductive layer and the second conductive layer, electromagnetic interference is unlikely to occur. Therefore, in a case where the composite structure is provided in a vehicle such as a flying object, malfunction is unlikely to occur in the electronic components mounted in the vehicle.

Further, since the first end portion of the first composite material is overlapped with the second end portion of the second composite material, the first composite material and the second composite material can be arranged on the end surface of the substrate without a gap. Therefore, the composite structure exhibits sufficient weather resistance and durability. In addition, the strength of the composite structure is maintained.

### Supplementary Note 2

In the composite structure according to Supplementary Note 1, the conductive portion may be the fastening member (74) configured to fasten the substrate, the first end portion, and the second end portion.

In this case, the fastening member used for fastening the substrate, the first end portion, and the second end portion can be utilized as the conductive portion. Therefore, the first conductive layer and the second conductive layer can be electrically connected to each other without performing special processing on the composite structure.

### Supplementary Note 3

In the composite structure according to Supplementary Note 2, the insertion hole (72) through which the fastening member is inserted may be formed in the substrate, the first end portion, and the second end portion, and the sealant (80) may fill a space between the inner circumferential surface of the insertion hole and the fastening member.

The sealant seals between the inner circumferential surface of the insertion hole and the fastening member. Therefore, rainwater or the like is prevented from entering the insertion hole, and corrosion of the fastening member is therefore avoided. As a result, the joint strength between the substrate, the first end portion, and the second end portion is maintained.

### Supplementary Note 4

In the composite structure according to Supplementary Note 3, the sealant may have electrical conductivity.

According to this configuration, the fastening member can be electrically connected to the first conductive layer and the second conductive layer reliably via the conductive sealant.

### Supplementary Note 5

In the composite structure according to Supplementary Note 1, the conductive portion may be the conductive coating (82) that is formed so as to cover the end surface (51a) of the first end portion and is in contact with the second end portion.

The first conductive layer and the second conductive layer can be electrically connected to each other via the conductive coating even at locations where the fastening member cannot be used.

### Supplementary Note 6

In the composite structure according to Supplementary Note 1, the conductive portion may be the edge portion (55) of the first conductive layer that is located in the first end portion, and the edge portion may be bent toward the second end portion and may be in contact with the second end portion.

The first conductive layer and the second conductive layer can be electrically connected to each other via the edge portion of the first conductive layer even at locations where the fastening member cannot be used. Further, the operation such as applying a conductive coating is not required.

### Supplementary Note 7

In the composite structure according to Supplementary Note 1, the conductive portion may be the conductive solid (90) joined to the first end portion and the second end portion outside the overlapping portion.

In a case where the conductive portion is formed of the conductive solid, the conductive portion can be provided in the overlapping portion by a simple joining operation.

### Supplementary Note 8

The flying object (100) includes the substrate according to Supplementary Note 1 as the surface structural member (30), and includes the first conductive layer according to Supplementary Note 1 and the second conductive layer according to Supplementary Note 1 as the lightning protection structure (44).

When the flying object is struck by lightning, the lightning current flows along the first conductive layer and the second conductive layer that constitute the lightning protection structure. Therefore, the lightning current can be easily discharged into the atmosphere.

### Supplementary Note 9

In the flying object according to Supplementary Note 8, the conductive portion may be the fastening member (74) configured to fasten the frame (32) or the stringer (34), the substrate, the first end portion, and the second end portion.

The fastening member for fastening the frame or the stringer to the composite structure can be utilized as the conductive portion. In this case, in the composite structure, the fastening member fastens the substrate, the first end portion, and the second end portion. Therefore, the first conductive layer and the second conductive layer can be electrically connected to each other without performing special processing on the composite structure.

### Supplementary Note 10

In the flying object according to Supplementary Note 8, the conductive portion may be the conductive coating (82) that is formed so as to cover the end surface (51a) of the first end portion and is in contact with the second end portion.

The first conductive layer and the second conductive layer can be electrically connected to each other via the conductive coating even at locations where the fastening member cannot be used.

### Supplementary Note 11

In the flying object according to Supplementary Note 8, the conductive portion may be the edge portion (55) of the first conductive layer that is exposed from the first end portion, and the edge portion may be bent toward the second end portion and may be in contact with the second end portion.

The first conductive layer and the second conductive layer can be electrically connected to each other via the edge portion of the first conductive layer even at locations where the fastening member cannot be used. Further, the operation such as applying a conductive coating is not required.

### Supplementary Note 12

In the flying object according to Supplementary Note 8, the conductive portion may be the conductive solid (90) joined to the first end portion and the second end portion outside the overlapping portion.

In this case, the conductive portion can be provided in the overlapping portion by a simple joining operation.

### Supplementary Note 13

In the flying object according to any one of Supplementary Notes 8 to 12, the surface structural member may be made of a fiber-reinforced resin containing carbon fibers as reinforcing fibers.

According to this structure, the weight and thickness of the surface structural member can be reduced.

The present invention is not limited to the above disclosure, and various modifications are possible without departing from the essence and gist of the present invention.

1. A composite structure comprising:
a substrate; and
a first composite material and a second composite material that are disposed on a surface of the substrate,
wherein the first composite material is a sheet-shaped body including a first fiber layer, a first conductive layer laminated on the first fiber layer, and a first matrix resin impregnated into the first fiber layer and the first conductive layer, and the first composite material is laminated on the substrate in a manner so that the first fiber layer is positioned between the substrate and the first conductive layer,
the second composite material is a sheet-shaped body including a second fiber layer, a second conductive layer laminated on the second fiber layer, and a second matrix resin impregnated into the second fiber layer and the second conductive layer, and the second composite material is laminated on the substrate in a manner so that the second fiber layer is positioned between the substrate and the second conductive layer, and
the composite structure includes:
an overlapping portion formed by a first end portion of the first composite material being overlapped with a second end portion of the second composite material; and
a conductive portion configured to electrically connect, in the overlapping portion, the first conductive layer located in the first end portion and the second conductive layer located in the second end portion.

2. The composite structure according to claim 1, wherein
the conductive portion is a fastening member configured to fasten the substrate, the first end portion, and the second end portion.

3. The composite structure according to claim 2, wherein
an insertion hole through which the fastening member is inserted is formed in the substrate, the first end portion, and the second end portion, and a sealant fills a space between an inner circumferential surface of the insertion hole and the fastening member.

4. The composite structure according to claim 3, wherein
the sealant has electrical conductivity.

5. The composite structure according to claim 1, wherein
the conductive portion is a conductive coating that is formed so as to cover an end surface of the first end portion and is in contact with the second end portion.

6. The composite structure according to claim 1, wherein
the conductive portion is an edge portion of the first conductive layer that is located in the first end portion, and the edge portion is bent toward the second end portion and is in contact with the second end portion.

7. The composite structure according to claim 1, wherein
the conductive portion is a conductive solid joined to the first end portion and the second end portion outside the overlapping portion.

8. A flying object comprising:
the substrate according to claim 1 as a surface structural member; and
the first conductive layer and the second conductive layer according to claim 1 as a lightning protection structure.

9. The flying object according to claim 8, wherein
the conductive portion is a fastening member configured to fasten a frame or a stringer, the substrate, the first end portion, and the second end portion.

10. The flying object according to claim 8, wherein
the conductive portion is a conductive coating that is formed so as to cover an end surface of the first end portion and is in contact with the second end portion.

11. The flying object according to claim 8, wherein
the conductive portion is an edge portion of the first conductive layer that is exposed from the first end portion, and the edge portion is bent toward the second end portion and is in contact with the second end portion.

12. The flying object according to claim 8, wherein
the conductive portion is a conductive solid joined to the first end portion and the second end portion outside the overlapping portion.

13. The flying object according to claim 8, wherein
the surface structural member is made of a fiber-reinforced resin containing carbon fibers as reinforcing fibers.
